(19) United States
(12) Patent Application Publication
(10) Pub. No.: US 2007/0176404 A1
(43) Pub. Date: Aug. 2, 2007

(54) Stored gas inflator

(75) Inventor: Kanji Yano, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/699,363

(22) Filed: Jan. 30, 2007

Related U.S. Application Data
(60) Provisional application No. 60/743,189, filed on Jan. 30, 2006.

(51) Int. Cl. B60R 21/26

(52) U.S. Cl. 280/737

(57) ABSTRACT

An occupant protection system includes an airbag with inflator that directs a projectile into a burst disk. As the burst disk ruptures, high pressure gas releases into the airbag for inflating the airbag.

### CROSS-REFERENCE TO RELATED PATENT APPLICATIONS

This application claims priority to and the benefit of U.S. Provisional Application Ser. No. 60/743,189 filed on Jan. 30, 2006 and entitled “Stored Gas Inflator.” The aforementioned provisional application is incorporated by reference herein in its entirety.

### BACKGROUND

The present invention relates to occupant restraint systems, and more particularly, the present invention relates to inflators for automotive airbags.

Inflators have been provided that to inflate an airbag during an emergency condition such as, e.g., an accident. When triggered, a stored gas type inflator releases compressed gas into the airbag to inflate it. To ensure that the airbag is reliably inflated, the size of the inflator bottle, which contains the compressed gas, is generally selected to correspond to the size (i.e., volume) of the airbag. Due to the various sizes of airbags (e.g., driver, passenger, side, etc.), a corresponding variation has resulted in the size of inflator bottles.

The inflators associated with the various inflator bottle sizes have conventionally been triggered using two different arrangements. In the first arrangement, initiators have been positioned outside of the inflator bottles. By positioning the initiator outside of the inflator bottle, a high amount of force must be generated by the initiator in order to overcome the opposing high pressure contained in the bottle and to rupture the burst disk separating the bottle from the airbag. In the second arrangement, an initiator is positioned inside the inflator bottles, but at a location remote from the burst disk leading into the airbag. The distance between the initiator and the sealed opening in the bottle for passing the compressed gas into the airbag may lead to problems in operation. U.S. Pat. Nos. 6,805,376 and 6,981,718 are incorporated herein by reference in their entireties.

### SUMMARY

Disclosed embodiments of an inflator, position the initiator, coupled with a second burst disk, close to the burst disk through which compressed gas travels into an airbag. As a result, the burst disk leading into the airbag can be easily and reliably ruptured.

In one exemplary embodiment, an inflator for inflating an airbag includes a bottle configured to contain a high pressure gas. The bottle includes an outlet located at one end of the bottle. The outlet is sealed by a burst disk. A initiator is connected to the bottle and configured to contain a propellant gas. A nozzle is located in the bottle and sealed by a projectile. The nozzle is configured to receive propellant gas from the initiator. The initiator and nozzle are configured so that the propellant gas ignites and passes into the nozzle causing the projectile to be directed away from the nozzle toward the burst disk. The burst disk is configured so that when the projectile contacts the burst disk, the outlet is unsealed and the high pressure gas is released into the airbag.

In another exemplary embodiment, an occupant protection system for use in a vehicle includes an inflatable airbag and a bottle connected to the airbag and configured to contain a high pressure gas. The bottle includes an outlet located at one end of the bottle. The outlet is sealed by a burst disk. An initiator is connected to the bottle and configured to contain a propellant gas. A nozzle is located in the bottle and sealed by a projectile. The nozzle is configured to receive propellant gas from the initiator. The initiator and nozzle are configured so that the propellant gas ignites and passes into the nozzle causing the projectile to be directed away from the nozzle toward the burst disk. The burst disk is configured so that when the projectile contacts the burst disk, the outlet is unsealed and the high pressure gas is released into the airbag.

In another exemplary embodiment, an airbag module for use in a passenger vehicle, includes: an inflatable airbag; an adapter to which the airbag is secured; a bottle connected to the adapter and configured to contain a high pressure gas; a burst disk connected to the adapter and sealing the bottle with respect to the airbag; an initiator connected to the bottle and configured to contain a propellant gas; and a projectile in fluid communication with the initiator, configured to be directed towards the burst disk. The burst disk is configured so that when the projectile contacts the burst disk, the burst disk ruptures and high pressure gas is released into the airbag.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, and the accompanying exemplary embodiments shown in the drawings, which are briefly described below.

FIG. 1 is a cross-sectional view of an inflator according to an exemplary embodiment;

FIG. 2 is a cross-sectional view of the initiator and burst disks of FIG. 1;

FIG. 3 is a cross-sectional view of the inflator of FIG. 1 during a first stage of inflation in which the initiator is activated;

FIG. 4 is a cross-sectional view of the inflator of FIG. 3 during a second stage of inflation in which gas contained within a nozzle of the initiator is ignited by the initiator;

FIG. 5 is a cross-sectional view of the inflator of FIG. 4 during a third stage of inflation in which a projectile of the initiator is driven by expansion of the ignited gas within the nozzle in the initiator;

FIG. 6 is a cross-sectional view of the inflator of FIG. 5 during a fourth stage of inflation in which the projectile is driven through a burst disk;

FIG. 7 is a cross-sectional view of an inflator according to an exemplary embodiment;

FIG. 8 is a cross-sectional view of an inflator according to an exemplary embodiment; and

FIG. 9 is a perspective view of a vehicle having an occupant protection system according to an exemplary embodiment.

### DETAILED DESCRIPTION

Various embodiments will be described with reference to the drawings. Like numbers are used throughout the drawings to refer to the same or similar parts in each of the embodiments of the invention described herein.

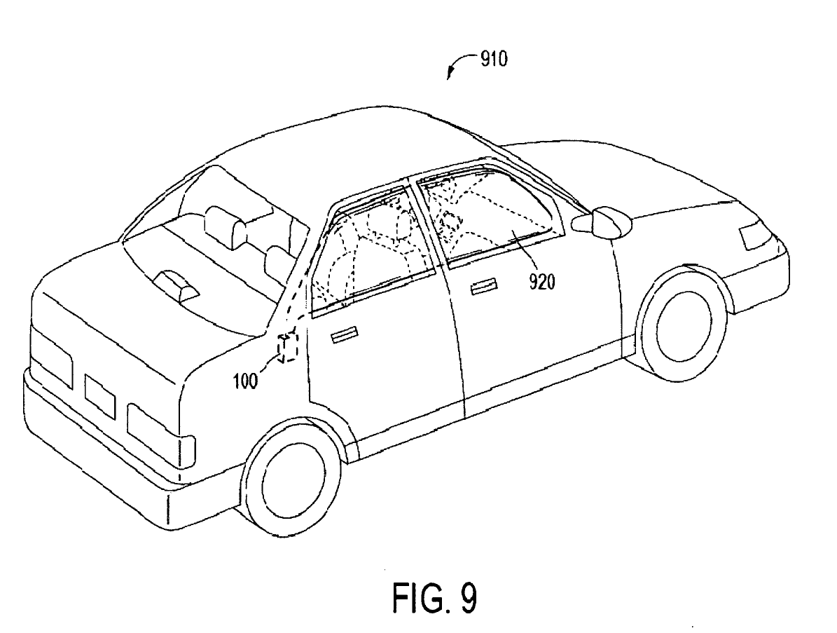

Referring to the Figures, FIG. 9 is a perspective view of an automobile 910 according to an exemplary embodiment. The automobile 910 includes an occupant protection system or a curtain-type airbag 920. The airbag 920 is installed along the roof side rail in such a manner that the airbag can deploy to extend between the structural components of the vehicle 910 and an occupant's body in the event of a side-impact collision. The airbag 920 is attached to an inflator 100 (as shown at one end of the airbag). The inflator 100 rapidly fills the airbag 920 with a high pressure gas when activated. While the inflator 100 is shown at one end of the airbag 920 in FIG. 9, it may be attached to any location on the airbag. For example, the inflator 100 may be attached to the B-pillar of the vehicle 910 and located at the middle portion of the airbag 920. Additionally, the inflator 100 may be activated using a number of methods. In one exemplary embodiment, the inflator 100 is activated by a processor or electronic control unit (ECU) that receives inputs from various sensors including, for example, crash sensors and occupant sensors.

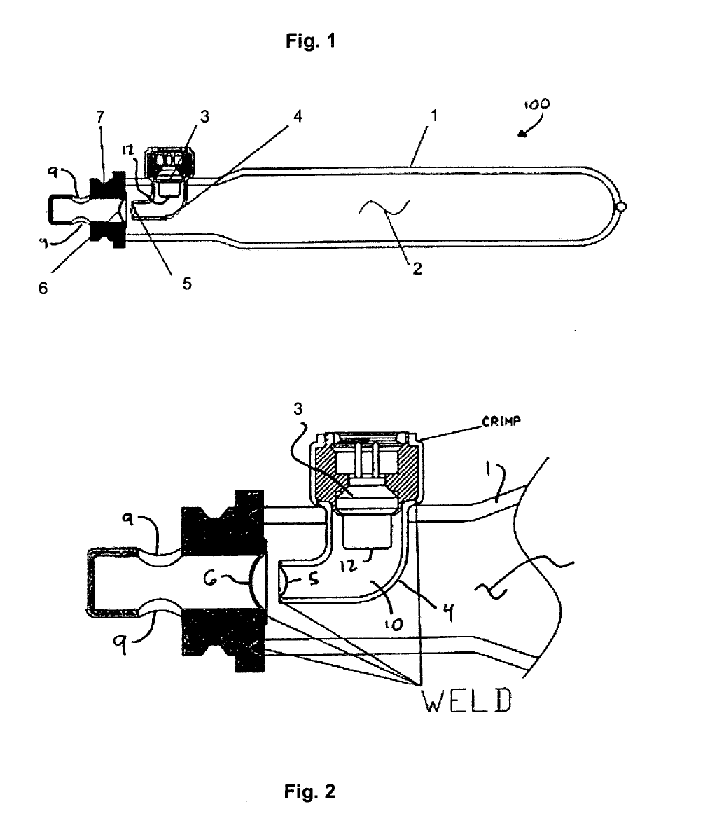

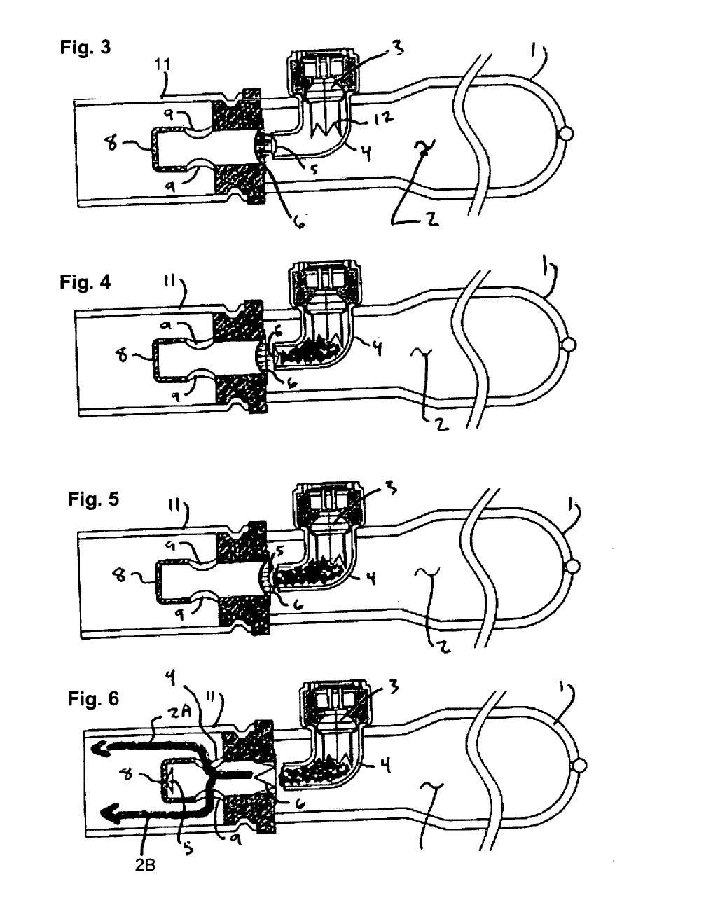

As shown in FIG. 1, an embodiment of an inflator 100 includes a bottle 1 and an initiator 3. The bottle 1 contains high pressure gas 2, which is configured to expand through a first burst disk 6 provided at an airbag inlet end of the bottle 1. The initiator 3, which is provided close to the first burst disk 6, is shown best in FIG. 2. The initiator 3 includes an igniter and igniter cover 12 (e.g., a disk, membrane, etc.), a nozzle 4 having propellant gas 10 therein, and a projectile or second burst disk 5. Inflation of an airbag 11 using the inflator 100 will now be described with reference to FIGS. 3-6.

As shown in FIG. 3, when the initiator 3 is activated, the igniter cover 12 is eliminated (e.g., withdrawn, removed, etc.) such that the initiator 3 can ignite a propellant gas housed with the nozzle 4. The ignition of the gas in the nozzle 4, which is shown in FIG. 4, causes the gas in the nozzle 4 to expand. As a result of the expansion of the gas in the nozzle 4, the first burst disk 5 is projected away from the nozzle 4 and toward the second burst disk 6, as shown in FIG. 5. When the first burst disk 5 impacts the second burst disk 6, the second burst disk 6 ruptures, as shown in FIG. 6. When the second burst disk 6 ruptures, the compressed gas 2 in the bottle 1 expands through the opening previously occupied by the second burst disk 6. After passing through the opening previously occupied by the second burst disk 6, the gas 2 is separated, by a deflector 8, into two gas streams 2A, 2B each of which flows through a respective outlet 9 into the airbag 11, thereby inflating the airbag 11. The deflector is attached to the bottle by an adapter 7 welded onto the bottle. It also should be noted that the deflector 8 also serves to catch the first burst disk 5, as shown in FIG. 6.

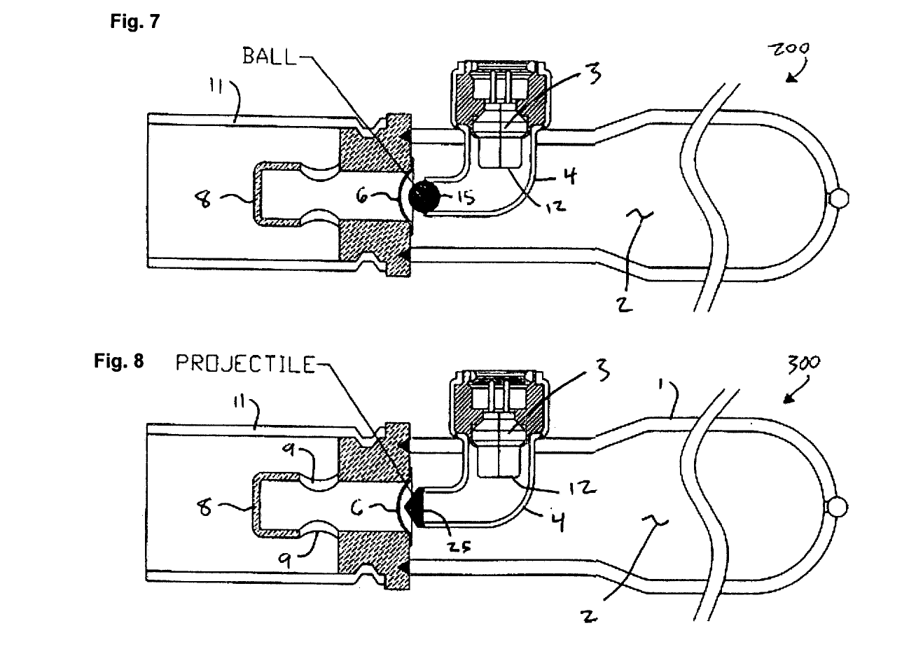

FIG. 7 shows an exemplary embodiment of an inflator 200 according to the present invention. In this embodiment, the first burst disk 5 is replaced by a ball 15. The ball 15 serves the same function as the first burst disk 5 and operates in the same way as the first burst disk 5.

FIG. 8 shows an exemplary embodiment of an inflator 300 according to the present invention. In this embodiment, the first burst disk 5 is replaced by a projectile 25, which may, as shown in FIG. 8, be in the form of an arrowhead or pointed object. The projectile 25 may serve the same function as the first burst disk 5 and may operate in the same way as the first burst disk 5.

The ball 15 and the projectile 25 may enhance the reliability of the inflator 200, 300. Specifically, if the ball 15 or projectile 25 travels at the same speed as the first burst disk 5, the pressure per area exerted on the second burst disk 6 will be greater due to the smaller (i.e., point) contact area in which the second burst disk 6 is impacted by the ball 15 or projectile 25, as compared to the first burst disk 5. As a result of the greater exerted pressure, the likelihood that the second burst disk 6 will rupture is increased.

As a result of the present invention, the burst disk leading into the airbag can be easily and reliably ruptured.

Given the disclosure of the present invention, one versed in the art would appreciate that there may be other embodiments and modifications within the scope and spirit of the invention. Accordingly, all modifications attainable by one versed in the art from the present disclosure that are within the scope and spirit of the present invention are to be included as further embodiments of the present invention.

What is claimed is:

1. An inflator for inflating an airbag, comprising:
a bottle configured to contain a high pressure gas, wherein the bottle includes an outlet located at one end of the bottle, and wherein the outlet is sealed by a burst disk;
an initiator connected to the bottle and configured to contain a propellant gas;
a nozzle located in the bottle and sealed by a projectile, wherein the nozzle is configured to receive propellant gas from the initiator;
wherein the initiator and nozzle are configured so that the propellant gas ignites and passes into the nozzle causing the projectile to be directed away from the nozzle toward the burst disk; and
wherein the burst disk is configured so that when the projectile contacts the burst disk, the outlet is unsealed and the high pressure gas is released into the airbag.

2. The inflator of claim 1, wherein the projectile is disk shaped.

3. The inflator of claim 1, wherein the projectile is a ball bearing.

4. The inflator of claim 1, wherein the projectile includes a pointed portion for contacting the burst disk.

5. The inflator of claim 1, wherein the initiator is welded onto the bottle.

6. An occupant protection system for use in a vehicle, comprising:
an inflatable airbag;
a bottle connected to the airbag and configured to contain a high pressure gas, wherein the bottle includes an outlet located at one end of the bottle, and wherein the outlet is sealed by a burst disk;
an initiator connected to the bottle and configured to contain a propellant gas;
a nozzle located in the bottle and sealed by a projectile, wherein the nozzle is configured to receive propellant gas from the initiator;
wherein the initiator and nozzle are configured so that the propellant gas ignites and passes into the nozzle causing the projectile to be directed away from the nozzle toward the burst disk; and
wherein the burst disk is configured so that when the projectile contacts the burst disk, the outlet is unsealed and the high pressure gas is released into the airbag.

7. The system of claim 6, wherein the projectile is disk shaped.

8. The system of claim 6, wherein the projectile is a ball bearing.

9. The system of claim 6, wherein the projectile includes a pointed portion for contacting the burst disk.

10. The system of claim 6, further comprising:
an adapter connecting the bottle to the outlet, wherein the burst disk is positioned within the adapter.

11. The system of claim 10, wherein the adapter is welded onto the bottle.

12. The system of claim 11, further comprising:
a deflector coupled to the adapter configured to separate the high pressure gas released from the bottle into at least two flow streams.

13. The system of claim 6, wherein airbag is a curtain-style airbag.

14. An airbag module for use in a passenger vehicle, comprising:
an inflatable airbag;
an adapter to which the airbag is secured;
a bottle connected to the adapter and configured to contain a high pressure gas;
a burst disk connected to the adapter and positioned to seal the bottle and separate the high pressure gas from the airbag;
an initiator containing a propellant and being connected to the bottle; and
a projectile positioned so that propellant from the initiator propels the projectile towards the burst disk;
wherein the burst disk is configured so that when the projectile contacts the burst disk, the burst disk ruptures and the high pressure gas is released into the airbag.

15. The airbag module of claim 14, comprising:
a nozzle located in the bottle and sealed by the projectile, wherein the nozzle is configured to receive propellant gas from the initiator;
wherein the initiator and nozzle are configured so that the propellant gas ignites and passes into the nozzle causing the projectile to be directed away from the nozzle toward the burst disk.

16. The airbag module of claim 14, further comprising:
a deflector coupled to the adapter configured to separate the high pressure gas released from the bottle into at least two flow streams.

17. The airbag module of claim 14, wherein the projectile is disk shaped.

18. The airbag module of claim 14, wherein the projectile is a ball bearing.

19. The airbag module of claim 14, wherein the projectile includes a pointed portion.

20. The airbag module of claim 14, wherein airbag is a curtain-style airbag.
